(19) United States
(12) Patent Application Publication
(10) Pub. No.: US 2010/0251560 A1
(43) Pub. Date: Oct. 7, 2010

(54) Holder

(76) Inventors: Gerald Thomas, Rosengarten-Rieden (DE); Juergen Rothbauer, Michelfeld (DE)

Correspondence Address: BOYLE FREDRICKSON S.C., 840 North Plankinton Avenue, MILWAUKEE, WI, 53203, US

(21) Appl. No.: 12/489,586

(22) Filed: Jun. 23, 2009

(30) Foreign Application Priority Data
Jun. 27, 2008 (DE) 102008031809.4

(51) Int. Cl. F26B 5/06; F26B 25/00

(52) U.S. Cl. 34/284; 34/239

(57) ABSTRACT

A sleeve consisting of metal and having a planar base manufactured to low fabrication tolerances for holding a cartridge, or other container for pharmaceutical products, filled with a pharmaceutical product, prior to, and during, freeze-drying is proposed. The sleeve has a cylindrical receptacle, into which a cartridge may be inserted. The base of that receptacle may have openings. Since the base of the metallic sleeve is manufactured to low fabrication tolerances, heat transfer from the cooling plate on which the sleeve containing the cartridge stands to the sleeve will be improved. Heat transfer from the sleeve to the interior of the cartridge will also be improved, since the latter is surrounded by the sleeve over the full length of the sleeve, thereby forming an enlarged surface, along which radiative heat transfer takes place. The sleeve preferably extends up to the level of the liquid pharmaceutical product arranged in the cartridge.

### TECHNICAL FIELD

The invention relates to the handling of pharmaceutical products during freeze-drying.

### DESCRIPTION OF THE BACKGROUND ART

Freeze-drying is one possibility for increasing the shelf lives of pharmaceutical products. However, the pharmaceutical products must be bottled beforehand. In the case of aseptic filling processes, the containers to be filled are first cleaned in washing machines, where they are treated with various media commonly employed in pharmaceutics in rotating-drum washing machines or tunnel washing machines. In the subsequent sterilization tunnel, they are reliably sterilized and depyrogenized by heating them to a defined temperature. The containers are then fed to the filling machine. The containers are conveyed through the filling machine on holders suitable for the various shapes they might have, where various methods for filling them are available. Special stoppers suitable for freeze-drying are then emplaced on the containers and the containers are fed to the freeze-drying process.

During freeze-drying, the containers, together with the pharmaceutical product contained therein, are brought into a cooling chamber, where they are cooled down to a temperature below the triple point of water. The cooling chamber is then transformed into a vacuum chamber, i.e., evacuated. The cooling chamber thus must be engineered to withstand the large differential pressures involved.

Although the water serving as a solvent freezes during the cooling stage, it sublimes during evacuation. The necessary thermal energy is provided by heating the cooling plate on which the containers in the cooling chamber are arranged. However, heat transfer between the cooling plate and the containers is not optimal, since the pharmaceutical-product containers, which are glass containers, lack accurately planar bases, which means that contact between them and the cooling plate will be at a few, isolated locations on their bases only, and elsewhere air pockets will be present between their bases and the cooling plate.

More or less densely packed product containers will be standing on such cooling plates, where those arranged around their perimeters will be closer to the walls of the cooling chamber. Uncontrolled, lateral, radiation of heat, in particular, radiating heat transfer through the walls of the cooling chamber, will cause the drying process to proceed more rapidly in the case of containers situated near the perimeters of cooling plates than will be the case for those situated near their centers.

The known containers for pharmaceutical products are, in particular, cartridges, syringes, loose vials, and vials lined up in troughs. Not stationary product containers are occasionally accommodated in magazines. In the case of freeze-drying pharmaceutical products accommodated in magazines, the thermal conductivities involved will also be poor.

In order to allow arriving at freeze-drying having cost-effective cycle times, that disadvantage must be compensated by increasing the temperatures involved. However, in the case of pharmaceutical products, the maximum tolerated temperatures are limited by the properties of the products to be involved and will usually be around room temperature. The resultant low temperature differences occasioned by the limitations imposed by the particular products to be involved, combined with poor heat conduction, will limit heat-transfer rates, which will increase the time required to complete the main drying cycle for removing the ice that has formed. That is the reason why drying products accommodated in magazines cannot always be cost-effectively performed.

There is already known a device for freeze-drying (DE 2637572) comprising a massive block made from heat conducting material. This block has several recesses with cylindrical walls for taking up a bottle in each recess.

### SUMMARY OF THE INVENTION

The invention is based on the problem of creating a means for more uniformly drying pharmaceutical products and thereby attaining shorter drying cycles.

In order to solve that problem, the invention proposes a holder for product containers employed in pharmacy, which, for simplicity, shall hereinafter be referred to as “cartridges,” and shall be construed as including other types of containers, such as syringes, vials, or similar, employed for accommodating pharmaceutical products. The invention also proposes the employment of such a holder during freeze-drying and other processing stages. Elaborations on the invention are covered by dependent claims.

Unlike the vials, cartridges, or other containers employed for accommodating pharmaceutical products, such holders, which are preferably metal sleeves, may be manufactured such that they have accurately shaped bases that then rest on cooling plates. The resultant large contact areas between the sleeves and cooling plates will cause the sleeves to acquire the temperatures of the cooling plates during heating. Radiative heat transfer will then also take place over the entire surfaces of the inner walls of the receptacles, and no longer occur exclusively at the small bases of the pharmaceutical-product containers. Heat conduction into the interiors of the cartridges will then be improved and thus proceed more rapidly. Due to the high contributions of radiative heat transfer to the total heat transfer from the sleeves to the product containers, product-container manufacturing tolerances will have little effect on heat conduction.

The steadfastness of product containers will then depend upon the shapes and dimensions of the sleeves, and no longer be dependent upon the shapes and dimensions of the product containers. Even not stationary containers may then be employed in freeze-dryers, without need for accommodating them in magazines, which will eliminate the disadvantages of employing magazines. Employing the sleeves will allow conveying not stationary containers on a system for conveying loose cartridges.

Various types of containers, e.g., syringes, vials, or cartridges, may also be handled in freeze-dryers using the same loading and offloading system.

Employing the sleeves, which may be adapted to suit the product containers to be involved, will also allow conveying product containers having various diameters on the same conveyor system.

The sleeves are preferably fabricated from metal. They will thus have non-negligible weights, which will shift the centers of gravity of the assemblies consisting of sleeve and container downward, thereby providing more secure conveyance.

Under an elaboration on the invention, it may be provided that the bases of the sleeves have holes or breakthroughs that facilitate heat transfer via convection.

Under an elaboration on the invention, it may be provided that the sleeves consist of a material suited to use in pharmacy, i.e., a sterilizable material, such as 316 L stainless steel.

However, the sleeves might also be provided with a coating, for example, an HC-coating, suited to use in pharmacy, in which case, the sleeves could be fabricated from a material unsuited to use in pharmacy, and such is proposed by the invention.

In particular, under an elaboration on the invention, it may be provided that the sleeves are configured in the form of monolithic units in order that they will have no joints that might inhibit heat transfer.

Employment of the sleeves and the resultant improvements in heat transfer will also allow employing plastic pharmaceutical-product containers.

In particular, it may be provided that the bases of receptacles are formed exclusively by a circumferential shoulder on which containers rest, while the remainder of receptacles' bases are open.

The sleeves are intended to improve heat transfer and, to the extent necessary, to also improve the steadfastness of product containers. It will therefore be sensible to provide that the sleeves have wall thicknesses that are greater in the vicinities of their bottom ends, which rest on cooling plates, and such is covered by the invention. Their minimum wall thickness is foreseen as falling within the approximate range 0.5 mm to 2 mm.

Due to the improved heat conduction between cooling plates and the containers arranged in the receptacles of the sleeves standing on it, the effects of uncontrolled radiative heat transfer emanating from sources other than the cooling plates will be offset within the sleeves.

Employment of the sleeves will also allow either reducing the temperature levels at which heat transfer takes place in the interest of preserving the integrities of the products involved or shortening the lengths of drying cycles while retaining temperature levels constant.

Under an elaboration on the invention, it is proposed that the containers be arranged in the sleeves prior to the freeze-drying stage, namely, during sterilization, in which case, sterilization will take place simultaneously with filling of the cartridges and their conveyance into the cooling chamber. The containers might also remain in the sleeves following freeze-drying, namely, during offloading and sealing, where the sleeves will primarily hold the containers in place and accommodate the containers during conveyance and idle periods. During filling, it might also be sensible to remove the cartridges from the sleeves and reinsert them into the sleeves following filling. The same applies to emplacing stoppers on containers.

### BRIEF DESCRIPTION OF THE DRAWINGS

Further features, details, and benefits of the invention will be evident from the claims and the abstract, the wordings of both of which are herewith made an integral part of the content of the description by way of reference thereto, the following description of preferred embodiments of the invention, and the drawings, which depict:

FIG. 1 a side view of a cartridge used in conjunction with the freeze-drying of pharmaceutical products;

FIG. 2 an axially sectioned view of a sleeve used for accommodating the container shown in FIG. 1;

FIG. 3 a side view of the cartridge arranged in the sleeve shown in FIG. 2;

FIG. 4 a sectioned view, corresponding to that of FIG. 2, of a second embodiment of a sleeve.

### DETAILED DESCRIPTION

FIG. 1 depicts a side view of a cartridge having the shape of a long, slim bottle and a circular cross-section. Due to the large ratio of its length to the diameter of its base 2, it is not very steadfast. It has an opening 4, on which a loose stopper is emplaced or laid during freeze-drying, on the end of a neck 3 having a reduced diameter on its upper end, i.e., that end thereof opposite its base 2.

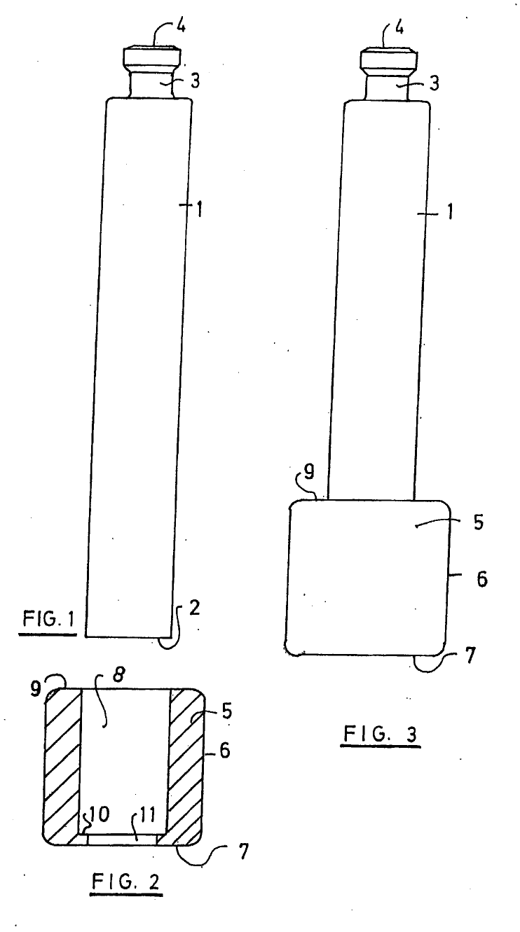

The invention proposes a sleeve 5, shown in a longitudinally sectioned view in FIG. 2, for handling such a cartridge 1 during freeze-drying. The sleeve 5 is configured in the form of a monolithic unit and consists of metal, for example, stainless steel, and has a smooth, cylindrical, outer surface 6. A base 7 that lies in a plane and has low manufacturing tolerances is formed on the underside of the sleeve 5. A cylindrical receptacle 8 coaxial to the sleeve's outer surface 6 and smoothly extending from the upper edge 9 of the sleeve 5 to the vicinity of the latter's bottom end, where it runs out onto a base that is formed by a shoulder 10, is formed within the sleeve 5. The shoulder 10 lies in a plane normal to the longitudinal axis of the sleeve 5 and parallel to its base 7. The base 10 has a central through hole 11. The inner diameter of the receptacle 8 is chosen to suit the outer diameter of the cartridge shown in FIG. 1, and is somewhat larger than the outer diameter of the cartridge 1. The sleeve 5 has a wall thickness that, in the case of the sample embodiment shown, is about 20% of the outer diameter of the sleeve 5. The cartridge 1 shown in FIG. 1 is inserted into the receptacle 8 in the sleeve 5 from above, and will then rest on the shoulder 10. The result thereof is depicted in FIG. 3. In that status, the assembly consisting of a metallic sleeve 5 and a cartridge 1 is emplaced on a supporting surface, for example, a conveyor belt, with which the assembly may be driven into the cooling chamber. The enlargement of its base and added weight of the metallic sleeve 5 improves its steadfastness, and the low manufacturing tolerances of the sleeve 5 improve heat transfer between the cooling plate and the sleeve 5. Heat transfer will proceed from the wall of the receptacle 8 to the interior of the cartridge 1. Based on FIG. 2 alone, it may be seen that the surface area, over which radiative heat transfer may take place, will be greatly increased, even for a relatively short sleeve 5.

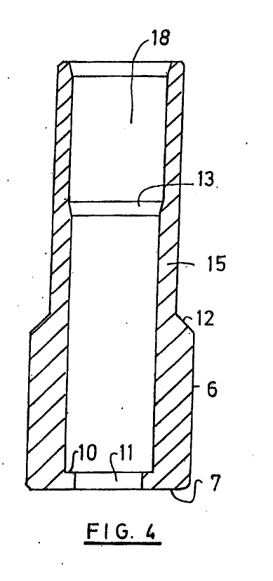

FIG. 4 depicts a sectioned view, corresponding to that of FIG. 2, of another embodiment of a sleeve. The lower section of the sleeve 15 is configured virtually identically to that of the sleeve 5 shown in FIG. 2. It thus has a base 7 having the same characteristics as that of the embodiment shown in FIG. 2. In the vicinity thereof, the outer surface 6 of the sleeve's lower section is also cylindrical. Above its lower section, there is an upper section having a smaller diameter adjoining a beveled shoulder 12 on its outer surface that is not carried over to its inner surface. The wall thickness of its upper section is thus less than that of its lower section.

A receptacle 18, whose lower section is also cylindrical and then blends into a second section having a somewhat larger diameter via a shoulder section 13, is formed in the interior of that sleeve 15. The overall length of the sleeve 15, which is intended for use in conjunction with the same cartridge 1 as the sleeve 5 shown in FIG. 2, is thus much larger. Inserting a cartridge 1 into the receptacle 18, will further increase the surface area over which heat transfer from the sleeve to the interior of the cartridge 1 may take place.

The larger wall thickness at the sleeve's lower section helps improve its steadfastness. At its upper section, a reduced wall thickness, which might, for example, fall within the range 1 mm to 2 mm, will be sufficient. The sleeve needs a wall thickness sufficient for transferring the radiative thermal energy inputs received via heat conduction. The larger wall thickness in the vicinity of its base both improves its steadfastness and enlarges the surface area, over which heat may be conducted into it by the cooling plate.

Employment of such sleeves provides the benefit that not stationary containers that formerly required accommodation in magazines may be brought into freeze-dryers without need for employing any such magazines. Various types of product containers, e.g., vials or cartridges, may be loaded into, and offloaded from, a freeze-dryer using the same loading system and offloading system. Product containers having differing characteristics, in particular, differing diameters, may also be conveyed on a single conveyor system without need for reconfiguring the conveyor system or changing its setup.

1. A holder for cartridges (1) or similar during freeze-drying of a pharmaceutical product contained in the cartridge (1) comprising a sleeve (5, 15) that is made of a heat-conducting material and has a planar base (7), which holder has an essentially cylindrical receptacle (8, 18) for inserting a cartridge (1), where the receptacle (8, 18) is configured such that the cartridge (1) is surrounded by the sleeve (5, 15).

2. A holder according to claim 1 having at least one through hole (11) in the base of the receptacle.

3. A holder according to claim 1, wherein the sleeve (5, 15) consists of a material suited to use in pharmacy.

4. A holder according to claim 1, wherein the sleeve (5, 15) has a coating suited to use in pharmacy.

5. A holder according to claim 1, wherein the sleeve (5, 15) is configured in the form of a monolithic unit.

6. A holder according to claim 1, wherein the sleeve (5, 15) has a coating on the inner wall of the receptacle (8, 18) that improves the latter's thermal emissivity.

7. A holder according to claim 1, wherein the base of the receptacle (8, 18) is configured such that the rim of the base of a cartridge (1) inserted therein abuts against a shoulder (10).

8. A holder according to claim 1, wherein the wall thickness of the sleeve (5, 15) is at least about 1 mm to 2 mm.

9. A holder according to claim 1, wherein the wall thickness of the sleeve (5, 15) in the vicinity of its lower end exceeds that in the vicinity of its upper end and tapers toward its upper end.

10. A holder according to claim 1, wherein the upper edge of the sleeve (5, 15) is approximately level with the level of the liquid contained in the cartridge (1) residing in the sleeve (5, 15).

11. Use of a holder according to any of the foregoing claims for accommodating a cartridge (1) during freeze-drying.

12. Use according to claim 11 for the purpose of accommodating the cartridge (1) during the entire process for manufacturing a pharmaceutical product.

13. Use according to claim 12, wherein the cartridge (1) remains in the sleeve (5, 15) during the entire manufacturing process.

14. Use according to claim 11, wherein the cartridge (1) is removed from the sleeve (5, 15) for filling and/or emplacement of a stopper.

15. Use according to claim 11 for the purpose of accommodating not stationary containers prior to, and during, freeze-drying.

16. Use according to claim 11 for the purpose of conveying not stationary containers on a system for conveying loose vials.

17. Use according to claim 11 for the purpose of accommodating cartridges (1) having various properties using sleeves (5, 15) having various sizes and/or diameters.

18. Use according to claim 11 for the purpose of improving the conveyability of cartridges (1).
